(19) United States
(12) Patent Application Publication
(10) Pub. No.: US 2009/0030780 A1
(43) Pub. Date: Jan. 29, 2009

(54) MEASURING EFFECTIVENESS OF MARKETING CAMPAIGNS PRESENTED ON MEDIA DEVICES IN PUBLIC PLACES USING AUDIENCE EXPOSURE DATA

(75) Inventors: Jeremy York, Bothell, WA (US); Paul Dixon, Seattle, WA (US); Thomas C. Opdycke, Bellevue, WA (US); Wan-Chung William Wu, Bellevue, WA (US)

Correspondence Address: PERKINS COIE LLP;PATENT-SEA, P.O. BOX 1247, SEATTLE, WA, 98111-1247, US

(73) Assignee: DS-IQ, Inc., Bellevue, WA (US)

(21) Appl. No.: 12/233,872

(22) Filed: Sep. 19, 2008

Related U.S. Application Data
(63) Continuation-in-part of application No. 11/619,506, filed on Jan. 3, 2007.
(60) Provisional application No. 60/756,149, filed on Jan. 3, 2006.
(60) Provisional application No. 60/973,673, filed on Sep. 19, 2007.

(51) Int. Cl. G06Q 10/00; G06Q 30/00

(52) U.S. Cl. 705/10

(57) ABSTRACT

Computational and computer-implemented methodological techniques are described for analyzing and presenting data on the audience response to audio and/or visual media advertising campaigns in public places. In various embodiments, these techniques employ a mechanism that assesses audience behavior to produce audience behavior data and audience exposure to produce audience exposure data, a network of display devices that records media events as media event data in a playlog, and a component that assembles the audience behavior data, audience exposure data, and media event data to produce data identifying media events that could have impacted audience behavior and data assessing campaign effectiveness as a measure of audience exposure.

### CROSS-REFERENCE TO RELATED APPLICATION(S)

This application is a continuation-in-part of U.S. patent application Ser. No. 11/619,506, entitled “MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES” filed on Jan. 3, 2007, which claims the benefit of U.S. Provisional Patent Application Ser. No. 60/756,149, entitled “SYSTEM AND METHODS FOR MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES” filed on Jan. 3, 2006, and which is incorporated herein in its entirety by reference. This application also claims the benefit of U.S. Provisional Patent Application Ser. No. 60/973,673, entitled “SUMMARIZING PERFORMANCE OF AND VALUING INVENTORY UTILIZED BY MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES” filed on Sep. 19, 2007, which is incorporated herein by this reference in its entirety.

### BACKGROUND

Many purchase decisions are made while customers are shopping in a store. To influence these decisions, manufacturers and retailers make effective use of product packaging and printed point-of-purchase advertising. The use of media devices—video displays, speakers, etc.—in stores, malls, and other public spaces promises to revolutionize in-store marketing by providing dynamic, captivating content. Retailers, network operators and advertisers would like to measure the benefits of such a system.

Unfortunately, audience response data and records of content played on media devices are often coming from two or more disparate systems that have no interactions. Even when the systems are integrated, it may not be easy to integrate the different types of data. For example, a customer may be intrigued by a marketing campaign displayed on a flat-screen display in a retail store environment; as a result, the customer purchases the promoted product. The purchase transaction record will typically be recorded through retail store's point-of-sale (POS) network, while the marketing campaign is broadcast via a separate digital signage network. Without methods to correlate these sources of data, traditional marketing analysis can only rely on analyzing the pure behavior response data (such as changes in sales over time) as their performance benchmark. The result is an aggregated, simplified analysis which is unable to determine how other factors impact campaigns performance.

The traditional way of evaluating a marketing campaign via mass media such as TV, radio or newspaper advertising is based on exposure measures, such as impressions or opportunities to see. These types of measures are typically summarized via metrics such as CPM (cost per thousand impressions) or GRP (gross rating points). None of these exposure based metrics reflect audience behavior after exposure to the marketing campaign.

The impact of promotional campaigns on audience behavior can exhibit different characteristics over time and in conjunction with other variables of interest. Aggregated audience response data lacks the detail required to measure these changes (particularly if the display frequency or nature of the content is changing over time), and exposure metrics fail to address the audience response.

### BRIEF DESCRIPTION OF THE DRAWINGS

FIG. 1A is a block diagram illustrating a system for gathering data on display devices and audience behavior in order to associate behavior with displayed campaigns in some embodiments.

FIG. 1B is a block diagram illustrating a system for gathering data on display devices, audience behavior, and audience exposure in order to associate behavior and audience exposure with displayed campaigns in some embodiments.

FIG. 2 is a flow diagram illustrating a general approach to associating audience behavior with media campaigns in some embodiments.

FIG. 3 is a flow diagram illustrating a temporal approach to associating audience behavior events with media campaigns in some embodiments.

FIG. 4 is a flow diagram illustrating a location-based approach to associating audience behavior events with media campaigns in some embodiments.

FIG. 5 is a flow diagram illustrating a method in some embodiments for computing uplift in audience behavior based upon associations between campaigns and audience behavior events.

FIG. 6 is a flow diagram illustrating a method for computing uplift in audience behavior by associating audience behavior with the playlogs generated in some embodiments.

FIG. 7 is a flow diagram illustrating a method in some embodiments for computing change in audience behavior by comparing observed metric with simulated values which are representative of what the metric value might be if media campaigns have no impact.

FIG. 8 is a chart diagram illustrating a comparison of an observed metric with simulated values which are representative of what the metric value might be if media campaigns have no impact.

FIG. 9 is a flow diagram illustrating a method in some embodiments for computing uplift in audience behavior based upon associations between campaigns and audience behavior events, using a predictive model (such as regression, ANOVA, neural networks).

FIG. 10 is a flow diagram illustrating a method in some embodiments for measuring how the impact of a campaign various across demographic groups and external factors (such as store size, time of year, weather, etc.), and using those measurements to either make predictions about future usage of the campaign, or as a tool in understanding audience behavior.

FIG. 11 is a flow diagram illustrating a method in some embodiments for assessing the change in impact of a campaign over time, which can optionally feed back into the management of the media devices where the campaign is displayed.

### DETAILED DESCRIPTION

Computational and methodological techniques are described for analyzing and presenting data on the audience response to audio and/or visual media campaigns (hereinafter “marketing campaigns”) in public places. These methods can be embodied in automated technology systems for monitoring and managing the marketing campaigns, or in a manual fashion as part of a measurement and reporting framework. In various embodiments of the invention, the computational and methodological techniques are applied to audience behavior data and logged records of what has been displayed or played on media devices to provide insight for users. The results can also serve as input to automated systems which seek to optimize the scheduling and selection of marketing campaigns.

In some embodiments, the effectiveness of a marketing campaign may be calculated by the system. The “effectiveness” of a campaign encompasses a variety of concepts including, but not limited to, the impact of the campaign on an audience, the cost effectiveness of the campaign, and/or the overall efficiency of the campaign. The effectiveness of a campaign may be based on measuring audience behavior and calculating expected impact per advertising effort expended. The effectiveness of a campaign may also be based on measuring audience exposure and calculating an incremental measure of audience behavior attributable to the audience exposure. Audience exposure may be measured by audience surveys, human observers, cameras, or by a variety of other monitoring devices.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

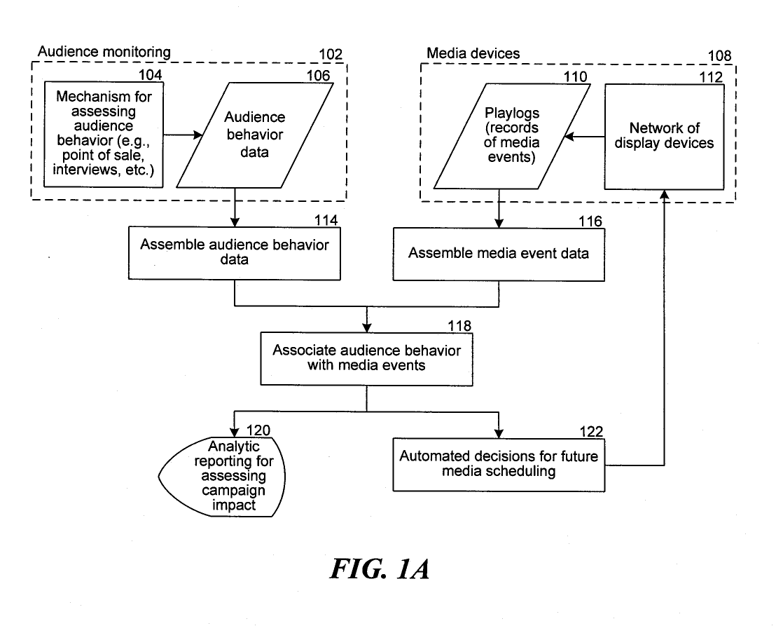

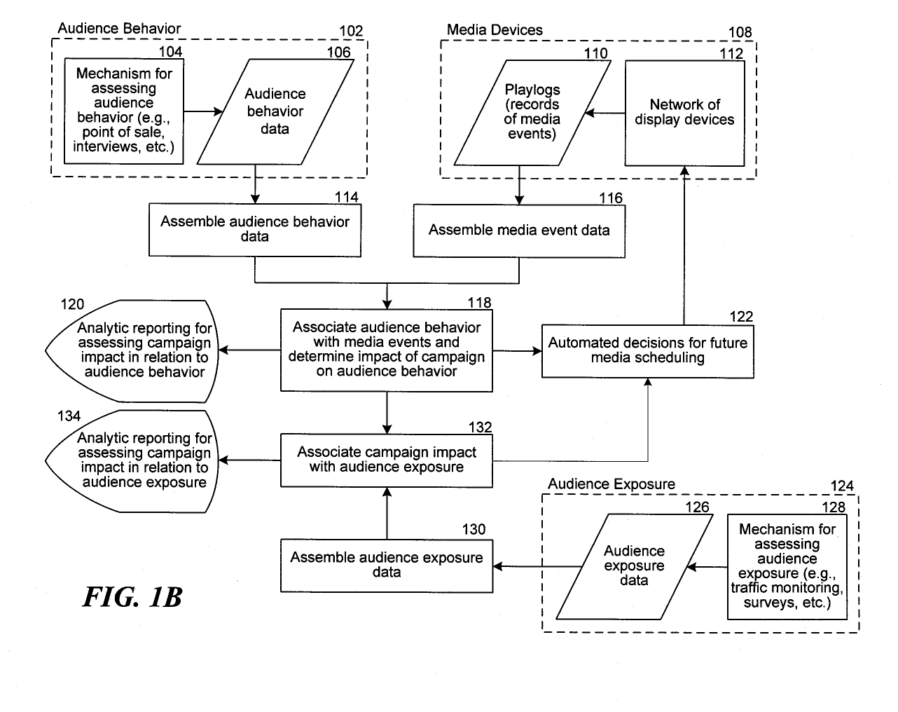

FIG. 1A is a block diagram illustrating a system in some embodiments for gathering data on display devices and audience behavior in order to associate behavior with displayed campaigns, provides an illustration of such a system. These associations are used to support analysis of impact and/or optimization of campaign scheduling.

The term media device will be used to describe devices which provide sensory input—examples include, but are not limited to, signs (flat panel displays, LCDs, projection devices, etc.), audio devices (speakers, headphones, etc.), interactive kiosks, devices which dispense an aroma, and so on. Marketing and other audio or video content displayed or played on media devices in public places will be referred to as campaigns or marketing campaigns. A specific time and place when a particular campaign was played or displayed will be referred to as a media event The people who are exposed to these campaigns are referred to as the audience, and each exposure of a member of an audience to a campaign is referred to as audience exposure event. Exposure is an “opportunity to see,” meaning simply that the audience was at a location and at a time when it could have seen, heard, or otherwise experienced the marketing campaign. An audience exposure event may therefore include, but is not limited to, an audience member looking at a media device or traveling by a media device in close enough proximity to see and/or hear the media device. Measurable actions taken by the audience are referred to as audience behavior events; information about many audience behavior events will be referred to collectively as audience behavior. Audience behavior events can include but are not limited to: entry into a facility or store (perhaps as recorded by a security device, or as detected by a video camera with subsequent automated or manual processing), entry into a particular section of a store, amount of time spent in the store or a section of the store, taking an item off of the shelf and placing it into a shopping cart or basket (perhaps detected with an RFID tag on the product and a system for tracking the location of those RFID tags), data that a customer entered during a customer session on an interactive kiosk, and the purchase of one or more products (data recorded may include the product identifier, the price paid, the quantity purchased, the store identifier, the cash register identifier, a customer identifier, etc.). If data about audience exposure events is available, the audience behavior event may further be characterized as occurring after an audience exposure event.

The system employs audience monitoring components and processes 102 and media device components and processes 108. The audience monitoring components and processes 102 include a mechanism for assessing audience behavior 104 to collect audience behavior data 106. The media device components and processes 108 include a network of display devices 112 that generate playlogs 110, or records of the media events depicted on the display devices during a campaign.

In an embodiment, a framework for an automated data feed is put in place. This framework accepts data from one or more businesses or other entities such as retail stores, shopping malls, and sports facilities. The data provided describes audience behavior with at least some information about the times and places that the behavior occurred. The audience behavior data may be aggregated by time period, e.g., foot traffic per hour, or it may list individual events, e.g., at this time a customer purchased this item. The framework also accepts data from a system of media devices, providing information on what media campaigns were delivered or intended to be delivered. Note that the methods of this invention can be implemented as part of an integrated system that includes the network of media devices and/or the system(s) that monitor and record audience behavior. This document describes methods which can subsequently be applied to correlate media events with audience behavior, and/or compute summaries of the impact or efficiency of the campaigns. These methods can also used to provide measures of effectiveness and efficiency of the various campaigns to a user. The computations and summary measurements can be prepared either in an automated fashion as data becomes available, or when a user requests them, or some combination.

In an embodiment, the audience behavior data and the media event data described above are manually obtained, such as by querying database systems or processing logs from cash registers, sign systems, monitoring devices, etc. The resulting data is then manipulated according to the methods described in this document, to correlate which campaigns could have influenced which audience behavior events, and/or used to compute summaries of the impact or efficiency of the advertising campaigns. These computations can be performed manually, or with a technology system implementing the methods of this invention. These results are then made available to users in some manner, such as the user interface of a software system, textual or tabular reports, and so on.

Numerous embodiments lie between the two described above, depending on which portions of the data gathering and processing are automated (whether scheduled or on-demand) or performed manually.

### Audience Behavior Data, Audience Exposure Data, and Media Event Data

Audience behavior data can come in multiple forms. Detailed data consists of a list of audience behavior events, including the times and places at which those events occurred. Aggregated data for audience behavior will report how many of a certain kind of audience behavior event occurred within a given time range and/or within a certain range of locations. Examples of aggregated data include, but are not limited to, units of a particular product purchased each hour per store, number of customers entering per day per store, etc. Both detailed and aggregated data can be complete—that is, they include all relevant audience behavior events. They can also be the result of a sampling procedure, in which only selected events are utilized. Sampling procedures are often applied when it is too difficult to deal with the volume of data (e.g., every single purchase in a nationwide chain of retail stores), or when it is too difficult to collect all of the data (e.g., administering a survey to every customer). The methods described in this document can be used for complete and/or sampled audience behavior data. Some methods behave differently for aggregated versus detailed audience behavior data.

Data from media devices will be referred to as playlogs. Playlogs can be obtained in many ways, including but limited to: records logged by a system that manages the devices, records of content broadcast to the devices from some central source, records logged by the devices themselves, a listing of campaigns on a DVD, CD or tape that was used to deliver content to the media device. Detailed data provides or implies which campaigns were being played on which devices at all times. Examples include but are not limited to: a set of records for all devices at all times; records of what instructions were delivered to the devices, optionally coupled with records of device failures, manual over-rides and the like. Aggregated data measures which span across lengths of time or multiple devices. Whether detailed or aggregated, the data recorded can include identifiers for campaign, media device, and/or location; duration of campaigns; and device status information. Whether detailed or aggregated, the media event data can be complete (records represent all relevant media events), or the data can be the result of sampling (records represent a selected portion of all media events). The methods described in this document can be used for complete and/or sampled media event data. Some methods behave differently for aggregated versus detailed media event data.

The system assembles audience behavior data 114 and media event data 116 from the audience monitoring components and processes 102 and media device components and processes 108, respectively. As will be described in greater detail herein, the system associates the media event data with the audience behavior data at an association step 118. Upon associating the audience behavior with media events, the system can provide analytic reporting for assessing campaign impact 120. The system can also support automated decision-making for future media scheduling 122, such as to drive the network of display devices 112.

In some embodiments, the system may also take into account audience exposure data. Whereas audience behavior data reflects a quantifiable action taken by a consumer (e.g., a purchase, entry of data at a kiosk, entry into a store), audience exposure data attempts to quantify the number people who were actually exposed to a campaign. FIG. 1B is a block diagram illustrating a system for gathering data on display devices, audience behavior, and audience exposure in order to assess the impact of audience exposure on campaign scheduling. As previously described with respect to FIG. 1A, the system assembles audience behavior data 114 and media event data 116, and associates the media event data with the audience behavior data at an association step 118. The media event data and audience behavior data may be used to provide analytic reporting for assessing campaign impact 120. In addition, the system receives data from various audience exposure monitoring components and processes 124. Audience exposure data 126 is compiled using various mechanisms 128 that will be described in greater detail herein. The system assembles the audience exposure data at an assembly step 130, and associates the audience exposure data with the determined campaign impact at an association step 132. The resulting association between the audience exposure data and the campaign impact may be used to generate reports and provide the reports to users of the system via a reporting process 134. The association between audience exposure and campaign impact may also be used to support automated decision-making for future media scheduling 122. Either through an automated mechanism, a manual procedure, or a supervised system (i.e., an automated system that produces recommendations which need to be approved by a user before proceeding), the information on the efficiency of the campaign can be used to change future scheduling.

### Association Between Audience Behavior and Media Events

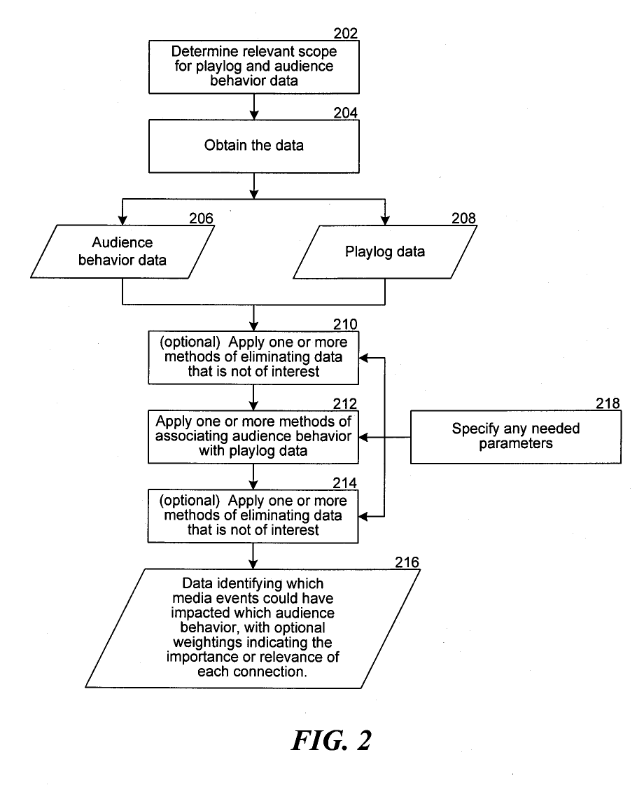

Correlating between non-aggregated audience behavior data and playlog data for in-store media devices involves several steps which can be implemented in various ways. These steps are illustrated in FIG. 2, which is a flow diagram illustrating a general approach to associating audience behavior with media campaigns in some embodiments. Relevant parameters can be specified, and the relevant playlog and audience behavior data can be identified (for example, data for a certain day in a certain set of locations; another example would be all available data for a certain brand for all locations for a year). Note that the playlog data can determine which audience behavior data is relevant, and vice versa. A method or combination of methods is applied to connect or correlate playlog data with audience behavior data. This process is referred to as association. Optional rules can be applied before or after the association step, and multiple methods of association can be applied. The connections drawn between the playlog data and audience behavior can then be summarized or used an input into further analysis.

This method will now be described with reference to FIG. 2. At block 202, the method determines the relevant scope for playlog and audience behavior data. The scope can be based on time, location, brand, or some other parameter or combination of parameters.

At block 204, the method obtains the data, such as by employing the logic of blocks 114 and 116 of FIG. 1. This obtained data includes audience behavior data 206 and playlog data 208.

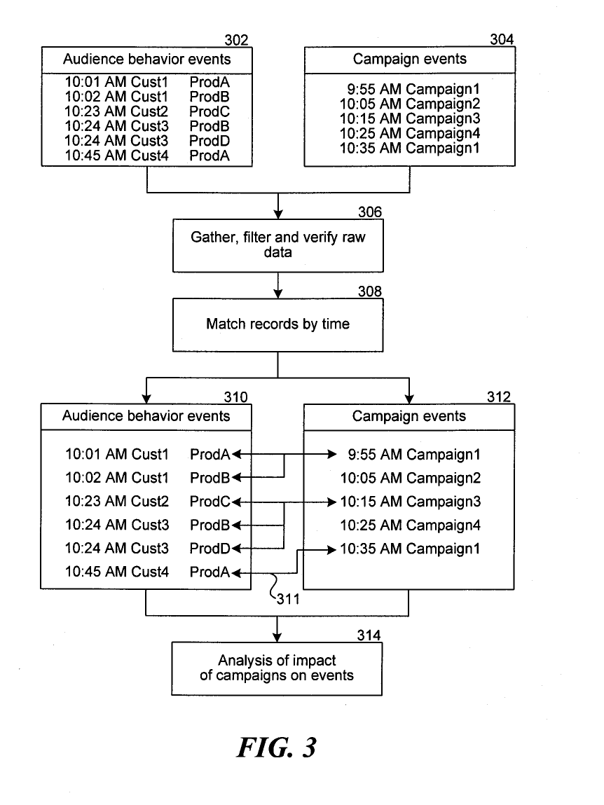

Based on a specification of parameters 218, the method can apply one or more methods (1) to eliminate data that is not of interest at block 210; (2) to associate audience behavior with playlog data at block 212; and/or (3) further eliminate data that is not of interest at block 214. An example of a method applied at block 212 is described in further detail below in relation to FIG. 3.

At block 216, the routine provides data identifying a correspondence between media events and audience behavior. The data the routine provides can include weightings indicating the importance or relevance of each identified connection between media events and audience behavior.

A method for associating audience behavior with playlog data is referred to as temporal association. FIG. 3 is a flow diagram illustrating a temporal approach to associating audience behavior events with media campaigns in some embodiments. Specifying parameters consists of choosing a time period d which is the longest reasonable period of time that would elapse for a normal customer between their exposure to the media device and displaying the audience behavior. In some embodiments, this time period can be any time interval of a specified duration. This time period d can vary depending on the store, media, products promoted, media device or other factors. For example, if the media device is a digital screen in the front window of a store, and the audience behavior event is a customer entering the store, the time period d may just be one or two minutes. If the media device is a television in a far corner of a large department store, and the behavior event is the customer making a purchase at a cash register, the typical customer may take as long as 20 minutes to check out after having seen the media.

Gathering the playlog and audience behavior data in the temporal association method is performed as follows. The two types of data should be for the same locations; for example, audience behavior in a certain set of stores, and playlogs for the devices in that same set of stores. The two types of data should also overlap in terms of time, with the additional stipulation that playlog data that occurs within the time period d before any audience behavior should be included. For example, if using audience behavior that occurred between 12 pm and 10 pm, and the time period d is 30 minutes, then any playlog data in the timeframe from 11:30 am to 10 pm is needed.

The main step of making temporal connections between audience behavior and media events works as follows. For an audience behavior event happening at time t, refer to the playlog and find all playlog in the same location which occurred within or overlapped with the range from time t to time t-d. This provides data on the set of media events which could have influenced the audience behavior. Before, during or after the process of making connections between audience behavior and playlogs, the method can apply filters based on a priori knowledge to eliminate certain media events from being associated with certain types of audience behavior (e.g., the purchase of a screwdriver was probably not influenced by an audio/visual cola advertisement). The method can also weight the importance of the associated playlog events according to the time duration and/or media device for each playlog event. One method of such weighting is described in the following example: if a purchase of a cola product was associated with one 20-second cola media campaign A which played once, and with two instances of the 40-second cola media campaign B, then campaign B is 4 times as important as campaign A in being connected with the cola purchase. Another method might be based upon the size, quality or placement of the display device. For example, a large media player that's located near a product may be weighted higher than a small media player far from the product. When evaluating campaign A, it is possible to restrict attention to only those audience behavior events which have been associated with it. Alternatively, when evaluating the purchases of cola, it is possible to examine what proportion of them had been associated with which campaigns. Audience behavior events which were associated with no media campaign events may also be of interest.

When the audience behavior and/or the playlog data has been aggregated, a slightly different method can be applied. One such possibility is to create hypothetical data and proceed with the method described above. For example, if there were 100 purchases of a product during a day in a particular store, we could invent 100 purchase transactions and assign them to various times throughout the day, perhaps evenly spaced across the time the store was open. Another possibility is to identify a time span which has been aggregated, associate all possible media campaigns happening within that time span to all audience behavior events happening within that time span. As above, these associations can optionally be weighted according to the total duration of each media campaign during the time span.

In the illustrated embodiment, audience behavior events 302 are temporally correlated with campaign events 304 as follows. At block 304, the method gathers, filters, and verifies raw data. At block 308, the method matches records by time. In the illustrated embodiments, arrows 311 illustrate the correlation. As an example, customer Cust1 behaved in some recognizable manner in relation to products ProdA and ProdB, which because of times 10:01 and 10:02, respectively, can be attributed to campaign Campaign1, which occurred at 9:55. Thus, customer Cust1's behavior is temporally matched with campaign Campaign1. Accordingly, the temporal association can be analyzed 314 to determine the impact of various campaigns.

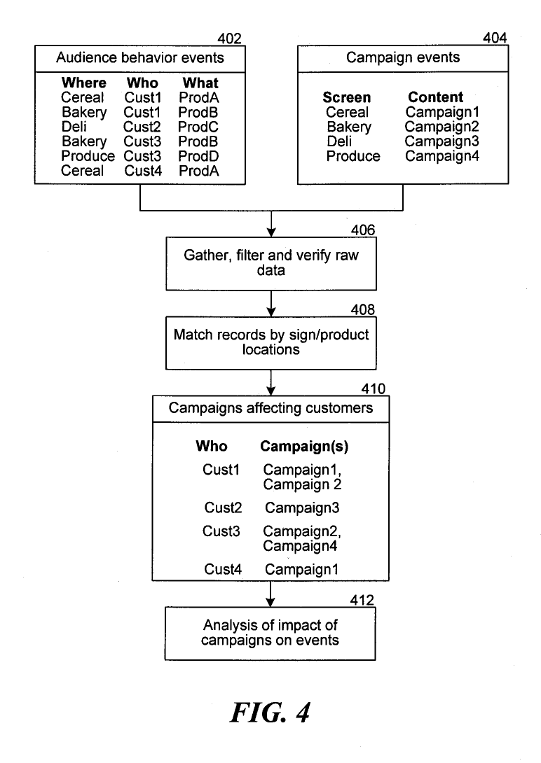

Another method for implementing the logic of block 212 of FIG. 2 is to correlate the data according to the locations of audience members and media devices in a public space or retail location, such as a store. FIG. 4 is a flow diagram illustrating a location-based approach to associating audience behavior events with media campaigns in some embodiments. Evidence indicating an audience member was in close proximity to a particular display device at a particular time can be used to associate that audience member's activities with the media events that occurred on that display device at that time. For example, suppose there is a prominent display device which frequently plays a given advertising campaign, and it is located in a particular department of a retail store. Consider a customer who has placed a product from that department in their shopping basket or purchased that product; it can be assumed that the customer has seen that display device and the corresponding campaign. In this way, a set of customers (and any corresponding data on the behavior of those customers) can be associated with a particular campaign.

In addition to audience behavior data that may be used to imply the presence of an audience member near a display device when a digital media campaign is being played, there are other direct ways to associate audience members with the campaigns they are likely to have seen (i.e., to determine audience exposure to a campaign). For example, if shopping carts or loyalty cards have RFID tags or other tracking devices embedded in them, then devices in a public place or retail store can track the location of those audience members, and record which display devices the audience members have come near at which times. Interactive kiosk devices can combine a media display with interactive functionality which can be used to identify the audience member who has interacted with the kiosk; thus, if a particular audience member has interacted with the kiosk at a certain time, they are likely to have seen whichever campaigns were displayed at the kiosk around that same time. As another example, audience exposure to a campaign may be determined through the use of panels or focus groups, in order to assess the audience's ability to recall the presence of the campaign or details of the campaign's messaging. As yet another example, audience exposure may be calculated via behavioral observations, in which quantitative measures of foot traffic or audience counts are employed to estimate the potential size of the audience. Such behavioral observations can be performed by dedicated human observers or through the use of cameras or other monitoring devices such as motion detectors, heat sensors, etc., placed in such a fashion as to observe the audience observing the digital signage. Traffic counts may in turn be extended by more complex metrics and detailed observations. For example, monitoring devices such as digital cameras may be used in conjunction with software (e.g., facial recognition) to move beyond simple traffic counts to estimates of demographic parameters, audience dwell time, engagement (e.g., time spent oriented towards the screen, etc.). These more detailed measures of audience exposure may also be captured by human observers, via self reporting, through panel survey, etc. Traffic counts can be expressed as simple averages, or in great detail, including temporal patterns (for example, traffic counts by hour of day, day of week, season, during holidays, during special events of various kinds, etc.). This type of data, combined with playlogs, is sufficient to determine which campaigns any given audience member has been exposed to, so that this information can be correlated with data on the behavior of that audience member.

Regardless of the method of collecting data about audience exposure to a campaign, some or all of the collected data (e.g., data pertaining to audience traffic counts, audience behavioral observations, audience demographics, audience dwell time, determinations of views to identify audience members who actually looked at the display device, determinations of unique and repeat viewers, audience recall, attitudinal surveys, etc.) may be summarized into an aggregate measure of audience exposure. The data may be summarized to create an aggregate measure of audience exposure using a variety of techniques, including but not limited to: via indices, rankings, absolute values (for example, by reporting some measure of total campaign impact in conjunction with a measure of total audience exposure), qualitative descriptors, nonparametric and parametric statistical descriptions and relationships, or the incorporation of such data as parameters into modeling studies. The summarization may be simple, as in a simple average estimate of traffic in a given location, or complex, as for example when traffic counts are quantified with a high degree of resolution in space and time. The resulting calculation of audience exposure may be used along with demographic and behavioral observations to inform detailed models that translate advertising screen time to audience impressions. Such models may employ concepts such as Opportunity to See (OTS) to describe the relationship between audience count or traffic and actual audience exposure. Often, such models produce results phrased in terms such as GRPM, or Gross Ratings Per Mil (that is, thousand), in order to yield metrics analogous to those use in traditional broadcast media such as television.

According to the embodiment illustrated in FIG. 4, at block 406, audience behavior events 402 and campaign events 404 are gathered, filtered, and verified. The records (e.g., audience behavior events and campaign events) can be matched by sign and/or product locations, thereby creating a correlating table 410 showing how campaigns affected customers. For example, customer Cust1 may have acquired product ProdA from the cereal section and product ProdB from the bakery section. These sections had campaigns Campaign1 and Campaign2, respectively. Thus, the method correlates customer Cust1 with campaigns Campaign1 and Campaign2. This table can be analyzed 412 to determine the impact of campaigns.

The temporal association and location-based correlation methods can be combined in various ways. For example, the temporal association can be combined with the location of shopping cart items. Perhaps there is a prominent display in a particular department of a store, but it is playing a variety of campaigns, and a record of its activity is recorded in a playlog. If a customer purchases an item from that department, then they are likely to have seen the display, and so their purchases can be correlated with the campaigns from the playlog in the method described for temporal association.

### Calculating Campaign Lift Impact

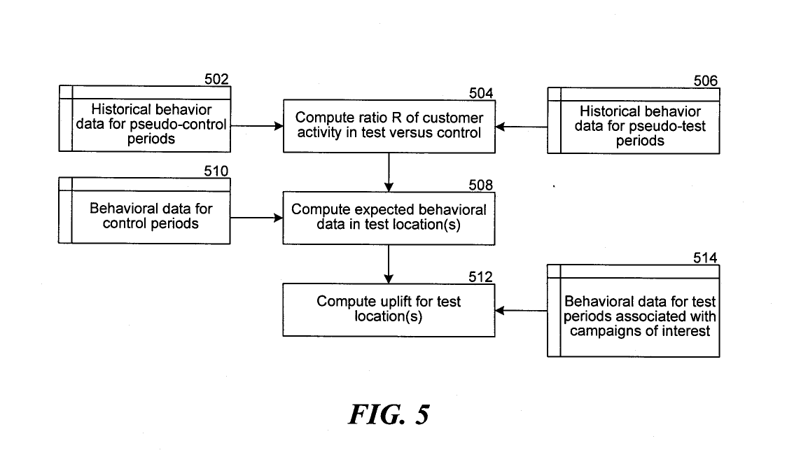

One approach to computing the impact of one or more media campaigns on audience behavior is to first determine how different the audience behavior was in places and times exposed to the media campaigns (termed test periods) as compared to otherwise similar places and times without the media campaigns (termed control periods). FIG. 5 is a flow diagram illustrating a method in some embodiments for computing uplift in audience behavior based upon associations between campaigns and audience behavior events. Historical data for the same audience behavior events, in the absence of any related media campaigns in either the test or the control periods, can be used to determine the relative frequency of audience behavior events in the test periods versus the control periods. Consider a historical time period during which no relevant media events occurred, and assume that a scheduling and deployment of the campaigns had been conducted during that historical time. This allows the definition of pseudo-test period for the historical period, and a complementary pseudo-control period. For example, consider campaigns which were only displayed on even-numbered days in a certain set of stores (termed the test set of stores) for the month of October. In this case, the test period consists of even-numbered days in the test set of stores, and the control period consists of all data for the month of October for the stores not in the test set, as well as behavioral data from odd-numbered days in the test set of stores. The historical time period might be October of the previous year, and the pseudo-test period would comprise even-numbered days in October of the previous year in the test set of stores. Meanwhile, the pseudo-control period would comprise October of the previous year for stores not in the test set, as well as the odd-numbered days from stores in the test set. Let R equal the ratio of pseudo-test period audience behavior events to pseudo-control period audience behavior events for the historical time. At block 504, the method calculates R based on historical behavior data for pseudo-test periods 506 and historical behavior data for pseudo-control periods 502. The total count of audience behavior events in the control periods 510 is multiplied by R to produce the expected count of audience behavior events in the test periods 508 if no media campaigns were played. Subtracting that product from the actual count of audience behavior events in the test periods 514 provides an indication of the total impact of the media campaign events. This number, which could be positive or negative, is referred to as “lift.”

In another embodiment, computing the impact of one or more media campaigns on audience behavior is done by first determining how different one or more stores with the media campaigns (termed test stores) were in comparison to one or more otherwise comparable stores without the media campaigns (termed control stores). The method illustrated in FIG. 5 can also be employed to compute uplift in audience behavior based upon associations between campaigns and audience behavior events, where the campaigns are only shown in the test stores, and never shown in the control stores. Historical data for the same audience behavior events, in the absence of any related media campaigns in either the test or the control store, can be used to determine the relative frequency of audience behavior events in the test store versus the control store(s). Let R equal the ratio of test store audience behavior events to control store audience behavior events for the same historical time period. At block 504, the method calculates R based on historical behavior data for test location(s) 506 and historical behavior data for control location(s) 502. The total count of audience behavior events in the control store 510 is multiplied by R to produce the expected count of audience behavior events in the test store 508 if no media campaigns were played. Subtracting that product from the actual count of audience behavior events in the test store 514 provides an indication of the total impact of the media campaign events; we will call this number lift (although it could be negative).

This impact can be attributed to the various media campaign events in the following fashion. Determine what proportion of the audience behavior events for the time period was associated with any given media campaign, and distribute the total lift for the time period across those media campaigns proportionally. The total duration of each media campaign in association with the audience behavior events can optionally be used in this weighting. One way to implement this is to first determine what proportion of audience behavior events were not associated with any media campaign event; this proportion of the lift is determined to be due to other factors. The remaining lift can be distributed among the media campaigns as follows. Total the duration of all media campaign events which were associated with audience behavior events to form a denominator D. For any given media campaign, total the duration of all instances of it which were associated with audience behavior events, and call this number N. The ratio N/D is the proportion of the lift for the time period which can be attributed to the media campaign.

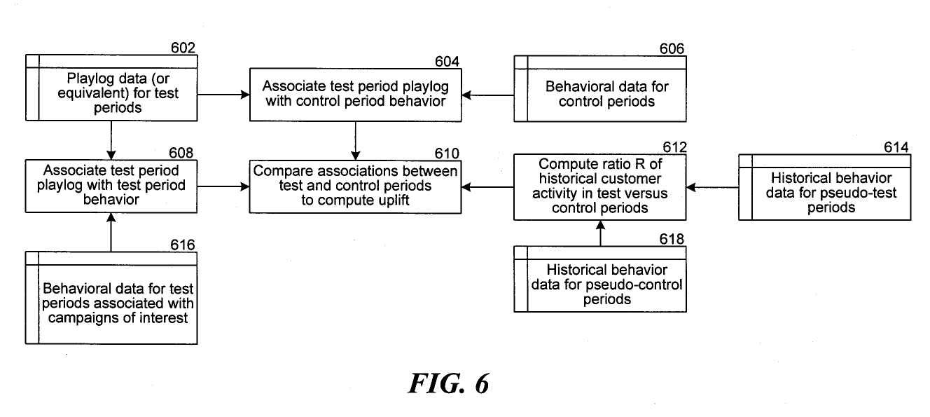

Another approach to computing the impact of media campaigns on audience behavior is to associate the media campaign events from one store with audience behavior events in a different comparable store which was not playing the same media campaign. FIG. 6 is a flow diagram illustrating a method for computing uplift in audience behavior based upon associations between campaigns and audience behavior events in some embodiments. Suppose a store, Store 1, has an LCD display that sometimes shows a cola advertisement. Suppose further that instances of putting cola products into a shopping cart (as measured by RFID sensors) are the audience behavior events of interest. At block 608, the illustrated method can associate shopping cart events (block 616) with instances of the media campaign being played (block 602), as described above in relation to FIGS. 3 and/or 4, and counts the total number of cart events associated with the media campaign. This count will be referred to as X. A method to find a comparable quantity from a control (Store 2, which is not displaying the media campaign) functions as follows. At block 604, the method associates the shopping cart events from Store 2 with the instances of the media campaign being played in Store 1 (block 606). The resulting count of shopping cart events, which will be referred to as Y, should be directly comparable to X, because the exact same time segments throughout the day (when the cola ad was being played) are being considered. At block 610, the method can compare associations between test and control locations to compute uplift. A scaling factor (as discussed previously) may have to be applied to Y before directly comparing it to X. At block 612, the method may calculate a ration R of customer activity during the test versus the control for use during the comparison of block 610. This ratio can be calculated based on historical behavior data for test locations 614 and historical behavior data for control locations 618.

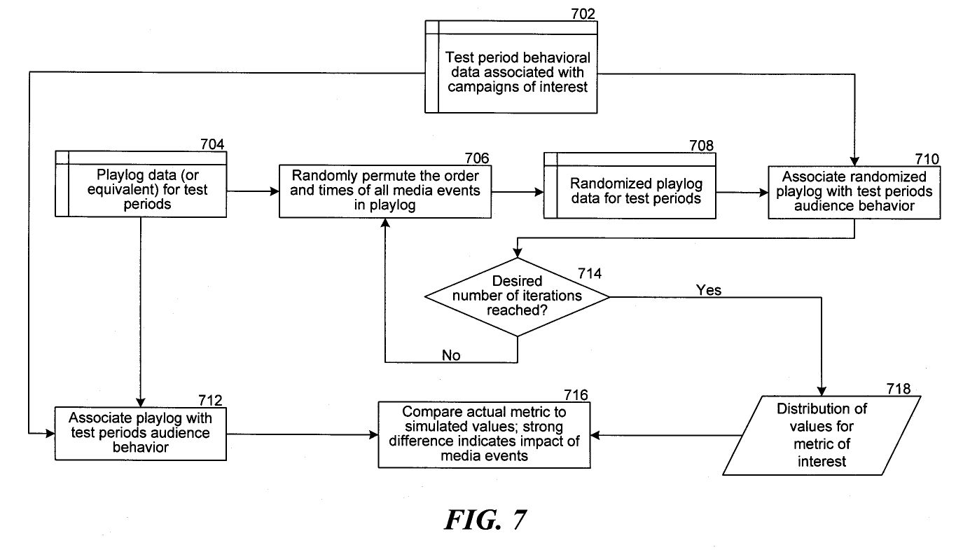

Another approach to computing the impact of media campaigns on audience behavior, which does not rely upon control periods, uses the statistical concept of randomization tests. FIG. 7 is a flow diagram illustrating a method in some embodiments for computing changes in audience behavior by comparing observed metrics with simulated values that are representative of what the metric value might be if media campaigns have no impact. At block 712, the method associates the audience behavior events 702 with the media campaign events 704 as described previously and determines the count of audience behavior events associated with the media campaign of interest. At block 706, the method permutes the order of the media campaign events, and at block 710 associates the audience behavior events 702 with this permuted alternate history of media player events 708, determines the count of audience behavior events associated with the media campaign of interest, and records the result. The method repeats the permutation step multiple times. At decision block 714, the method determines whether a desired number of iterations has been completed. If so, the method continues at block 718, where the distribution of values for metrics of interest can be analyzed or compared, such as at block 716, where the method compares the actual metric to simulated values. If the desired number of iterations has not been completed, the method continues at block 706. This produces a distribution of alternate counts of audience behavior events, which will be referred to as simulated counts. If the media campaign has an influence upon audience behavior, the actual associated count will look unusual in comparison with the simulated accounts.

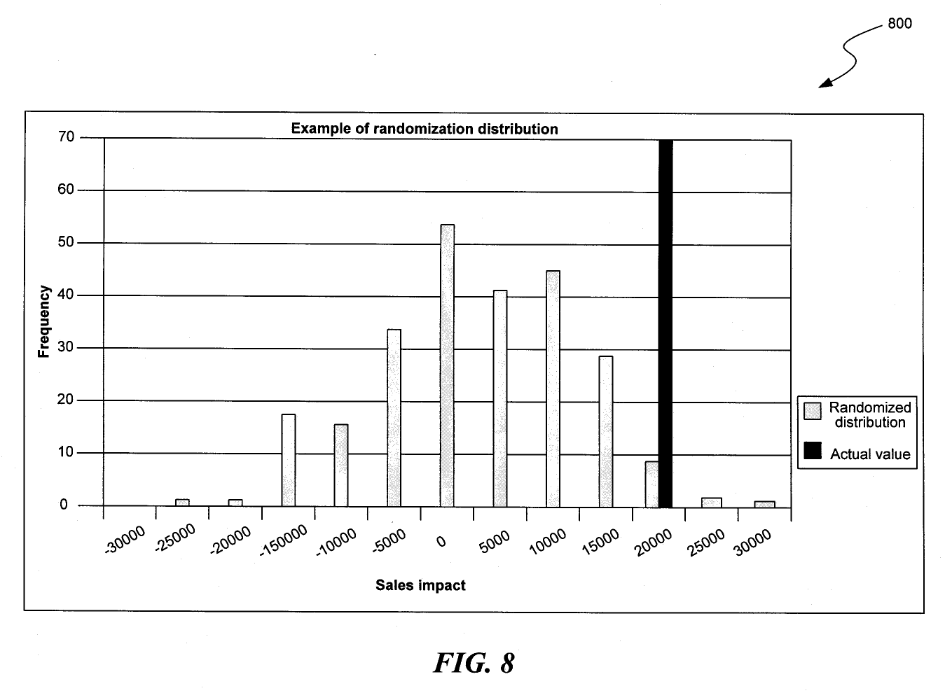

FIG. 8 is a chart diagram 800 illustrating a comparison of an observed metric with simulated values which are representative of what the metric value might be if media campaigns have no impact. The chart illustrates how likely various outcomes would be. Standard statistical significance methods can be applied to determine if the difference passes a hypothesis test threshold and can therefore be safely said to indicate an impact. The permutations can be random scramblings of the order of the media campaign events, or they could be the result of a deterministic iteration through possible orderings of the events. It is possible to use every possible alternate ordering of events, or a random or non-random sampling of those possible orderings.

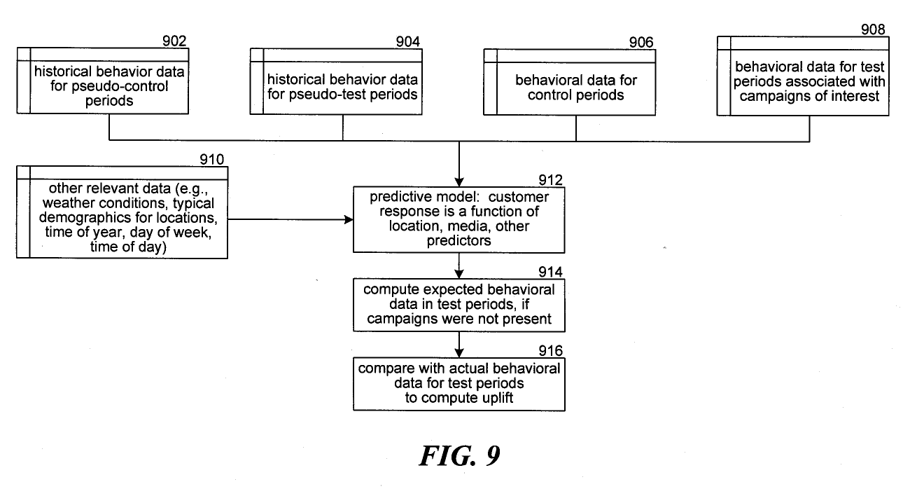

Another approach to computing the impact of media campaigns on audience behavior is to take the data of audience behavior events and the associated media campaign events (with optional weightings, as described in the paragraph on associations), and input them into standard predictive models. FIG. 9 is a flow diagram illustrating a method in some embodiments for computing uplift in audience behavior based upon associations between campaigns and audience behavior events, using a predictive model (such as regression, ANOVA, neural networks). Analysis of variance, linear models, generalized linear models, neural networks, and logistic regression models are just some of the standard methodologies familiar to someone practiced in the art. These models find relationships between a response variable and one or more predictor variables thought to influence it. The incidence or count of audience behavior events is identified as the response variable; store, time of day, geography, and which media campaign events were associated with the audience behavior event (optionally, with the weights as described above) are used as predictor variables.

According to the embodiment illustrated in FIG. 9, historical behavioral data for control location(s) 902, historical behavioral data for test location(s) 904, test period behavioral data for control location(s) 906, and test period behavioral data for test location(s) 908 are employed with predictive model 912, which also takes as input other relevant data (e.g., weather conditions, demographic information, time of year, day of week, time of day, and so forth). At block 914, the method employs the predictive model to compute expected behavioral data in test locations, which can then be compared with actual behavioral data for test locations to compute uplift, such as at block 916.

External Events and Correlations with Other Data

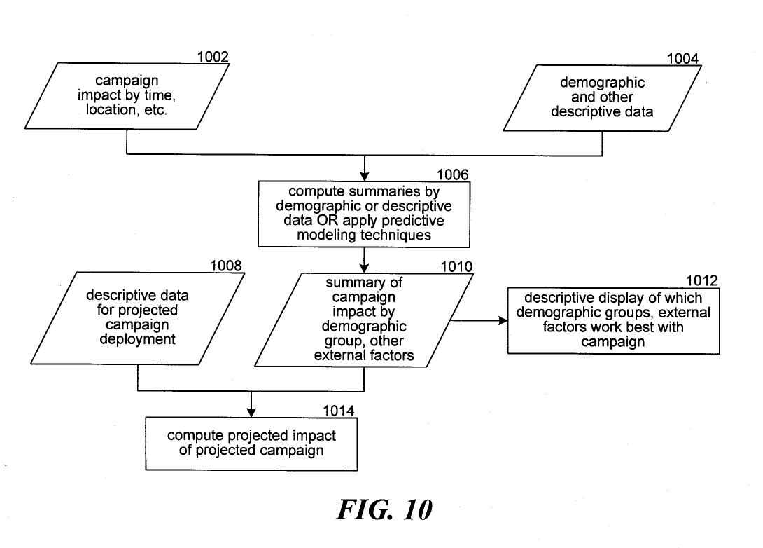

The methods for associating audience behavior events with in-store media events described above can be made more insightful when combined with external events as well as other types of data. FIG. 10 is a flow diagram illustrating a method in some embodiments for measuring how the impact of a campaign various across demographic groups and external factors (such as store size, time of year, weather, etc.), and using those measurements to either make predictions about future usage of the campaign, or as a tool in understanding audience behavior. In the illustrated embodiment, the associations and result metrics described above are correlated with demographic data and other external data. Examples of demographic groups include, but are not limited to, males, females, children 16 and under, Hispanic males, and Caucasian females between 30 and 40. Provided with estimates of the relative proportions of each of a number of demographic groups who are possible audience members, this information can be integrated with the measurement of the impact of the in-store advertising. Some assumption of how the audience responses are distributed across those demographic groups is required. One possibility is to assume that behavior is distributed proportionally—that is, if 30% of audience members are in a particular demographic group, then 30% of a particular kind of audience behavior occurred within that group. Another possibility is use other data or prior knowledge to determine the propensity of each demographic group to engage in the behavior being measured. With this assumption in hand, results from multiple stores can be combined to gain insight into the effectiveness of the in-store advertisements on each demographic group.

As an example, the method can be implemented as follows when using the assumption that behavior is distributed proportionally. Let pᵢⱼ be the proportion of customers in store i who belong to demographic group j. Let uᵢ be the impact of the in-store media advertising campaign(s) in store i, as measured by one of the embodiments described above. One method of aggregating data across multiple stores to determine the impact of the advertising on the demographic groups is to perform the following summation across all stores i:

$${\sum }_{i} {p}_{ij} {u}_{i} \qquad ( 1 )$$

The resulting measure is an estimate of the overall impact of the campaign(s) on the demographic group j. Another option is to use standard predictive modeling methods (linear models, neural networks, logistic regression, classification and regression trees, etc.) can also be used, in which demographic proportions and potentially other factors (pricing, stock, weather, etc.) are used as predictors and the campaign impact is the response. The resulting models can describe how important each demographic group or other factor is in determining the overall response. This in turn can be used to draw attention to particularly important factors in a report or computer interface, or to predict the impact of the campaign if used on a particular blend of demographic groups.

External factors such as store square footage, weather, time of year, other media exposure, and so on can also enter into the methods described above, in addition to or instead of demographics. External factors can also be included in the computation of the impact of a campaign. For example, store layout may impact the time lag d allowable between an in-store media event and an associated audience behavior date. It may be desirable to only associate purchase events from a particular set of cash registers with in-store media advertising played on devices located near those cash registers.

The illustrated method can receive as input (1) campaign impact by time, location, etc. (block 1002); and (2) demographic and other descriptive data (block 1004). At block 1006, the method computes summaries by demographic or descriptive data, or apply predictive modeling techniques to this data, to provide a summary 1010 of campaign impact by demographic group or other external factors. At block 1012, the method provides a descriptive display of which demographic groups and external factors work best with the campaign. At block 1014, the routine can compute the projected impact of a potential campaign by analyzing summary information 1010 with descriptive data for the potential campaign 1008.

### Summarizing Campaign Effectiveness

The measures of campaign impact described above can be used to describe the efficiency and cost effectiveness of the campaign. An overall summary of the effectiveness of an ad campaign can be given by a single number, which expresses the expected impact per advertising effort expended. One such summary measure is the expected incremental (attributable to the media campaign) count or measure of audience behavior per advertising effort exerted per store per time unit. We term this RPM (Results Per Media effort) for convenience:

$$R P M = \frac{\begin{matrix}incremental measure of customer behavior per \\ store per time unit\end{matrix} }{media effort per store per time unit} \qquad ( 2 )$$

The incremental measure of audience behavior could be average additional sales per day per store of the product or brand being advertised, attributable to the media campaign. Other possibilities include the addition foot traffic in the store, instances of customers adding the item to their shopping basket, etc. The media effort measure could be the average minutes of screen time per store per day, the number of times a screen displayed the campaign per store per day, the amount paid for having the campaign displayed in one store for one day, etc.

An embodiment of this is a set of techniques for computing and displaying summary data on the effectiveness of in-store media advertising on digital signage display and/or speakers.

An alternate embodiment would display total audience behavior (e.g., total foot traffic in the store, or total sales of a brand) rather than incremental behavior attributable to the ad campaign. Yet another embodiment would seek to summarize the advertising effort expected in order to achieve a particular measure of audience response.

Another embodiment is the computation and presentation of tabular and/or graphical summaries which provide an indication of how audience response varies with factors under the control of the advertiser or media device manager. This could be a graphical plot of how incremental audience behavior varies over the lifespan of the advertising campaign. It could also show a version of the RPM metric (incremental audience behavior per media effort expended) over the lifespan of the advertising campaign; this is particularly useful if varying levels of effort were expended during the lifespan of the campaign.

Another embodiment is the computation and presentation of tabular and/or graphical summaries of how the RPM metric varies with the level of media effort expended. This can be useful in determining the appropriate level of effort to expend in order to achieve maximum efficiency of the advertising effort.

The previously-described method computes a measure of marketing campaign effectiveness normalized by the media effort (i.e., by the amount of time devoted to displaying or playing the campaign on media devices). As an alternative to normalizing by media effort per location per time unit, the effectiveness of all or part of a campaign may instead be summarized by relating an incremental measure of audience behavior to any of a number of possible metrics which characterize audience exposure. As previously described with respect to FIG. 1B, the system may also measure or estimate audience exposure. Examples of audience exposure metrics include, but are not limited to: the number of times the campaign was viewed, the estimated number of people who may have been exposed to the campaign, the actual number of people who were exposed to the campaign, the number of people expected to recall the campaign, the proportion of a desired target market who will be exposed to the advertisement, the gross ratings points (as used to evaluate broadcast media) attributable to the campaign, etc. Audience exposure may be determined on a per location basis or on a multiple-location basis. Calculation of the effectiveness of a campaign can take the form of normalization, for instance by dividing the incremental measure of customer behavior by any of the audience exposure metrics which characterize audience exposure. For convenience, we term any such metric the “Lift Audience Quotient” (LAQ), which may be calculated in accordance with the following equation:

$$L A Q = \frac{\begin{matrix}incremental measure of audience behavior \\ at one or more locations\end{matrix}}{audience exposure at one or more location} \qquad ( 3 )$$

The numerator and denominator in equation (3) could optionally be normalized further, for example by store, time unit, or a combination of these and other measures. For example, the following LAQ is normalized on a per store and a per time basis:

$$L A Q = \frac{\begin{matrix}incremental measure of audience behavior \\ per store per time unit\end{matrix}}{audience exposure per store per time unit} \qquad ( 4 )$$

A LAQ metric may also be inverted to characterize the level of audience exposure required to achieve a certain or desired measure or degree of audience behavior. For convenience, we term any such metric the “Audience Lift Quotient” (ALQ), which may be calculated in accordance with the following equation:

$$A L Q = \frac{audience exposure}{incremental measure of audience behavior} \qquad ( 5 )$$

The numerator and denominator in equation (5) could also be normalized further, for example by store, time unit, or a combination of these and other measures. As an example, suppose that the incremental measure of choice of audience behavior was percentage uplift in unit sales, and audience exposure was measured in terms of gross rating points (GRP)—that is, thousands of impressions. Suppose that over its lifetime a campaign achieved twenty thousand impressions and produced 10% total unit uplift. One possible measure of ALQ would return a value of 2 (i.e., 20 GRPs/10% Unit Uplift); that is, two thousand impressions were required for each percentage point of total unit uplift.

Rather than characterizing campaign effectiveness as a ratio of incremental impact per audience exposure, campaign effectiveness may be characterized using any mathematical operation that takes into account the audience exposure data. For example, the audience exposure data, audience behavior data, and media event data may be manipulated by the system using indices, rankings, absolute values (e.g., by reporting some measure of total campaign impact in conjunction with a measure of total audience exposure), qualitative descriptors, nonparametric and parametric statistical descriptions and relationships, the incorporation of such data as parameters into modeling studies, or other information. In some embodiments, the system could model the expected amount of incremental customer behavior as a function of audience exposure, f(amount of audience exposure). The function could be a polynomial or other function, and might be informed by the performance of previous campaigns. The system could then look at a difference or ratio between the actual incremental behavior as compared to the predicted behavior based on the amount of exposure. Another useful measure is an index, for example, stating what percent of the expected behavior was actually achieved.

Once the audience exposure data has been assembled and compared with the campaign impact data, the system may make various display tools available to the user to allow the user to take action on the represented data. For example, the system may compute and generate tabular and/or graphical summaries that provide an indication of how audience response varies with factors under the control of the advertiser or media device manager. In some embodiments, these summaries include a graphical plot of how incremental audience behavior varies over the lifespan of the marketing campaign. In some embodiments, these summaries show a version of the LAQ metric (incremental audience behavior per unit of audience reached) over the lifespan of the marketing campaign; this is useful, for example, if varying levels of effort were expended during the lifespan of the campaign. In some embodiments, the tabular and/or graphical summaries provide an indication of how the LAQ metric varies with the level of audience exposure. Depicting variance of the LAQ metric can be useful, for example, in determining the appropriate level of effort to expend in order to achieve maximum efficiency of the marketing effort. One skilled in the art will appreciate that other tabular and/or graphical summaries may be generated by the system. For example, some embodiments may display total audience behavior (e.g., total foot traffic in the store) rather than incremental behavior attributable to the marketing campaign. Still other embodiments seek to summarize the audience reached in order to achieve a particular measure of audience response.

### Advanced Metrics for Profiling Digital Signage Campaign Performance

Of particular interest to retailers and advertisers is how the impact of an in-store media campaign varies over time. An embodiment of this invention is to measure the ad effect on audience behavior (using a total metric such as sales or traffic, an incremental metric such as additional sales attributable to the advertising campaign, or a version of the RPM metric described above), referred to below as “the metric,” over the lifespan of the campaign. These measurements can be summarized using a small number of parameters or by creating a composite index from those parameters. Examples of parameters that can be used in this way include
Maximum level of growth in the metric (first derivative)
Time before campaign reaches maximum value of the metric
Maximum level achieved in the metric
Time until maximum decay (first derivative) in the metric
Time until decay of metric tapers off (after peak, time when second derivative changes from negative to positive)
Maximum number of days of increasing decay after peak (after peak, number of successive days with negative second derivative)
Total (integrated) value of the metric across a specified time period.

The embodiment described above can be extended, by classifying the advertising campaign according to the values of one or more of the metrics above. For example, the campaign can be classified according to the time until maximum (duration of initial largest impact), and time until the decay tapers (time at which campaign matures and approaches stable, long term effectiveness). Classifying the value of each metric as high or low provides four possible combinations:
Fast time to maximum, fast time until decay tapers. For example, this behavior would be exhibited by a familiar campaign which is effective over a long time.
Fast time to maximum, slow time until decay tapers (or the decay never tapers off). For example, this behavior would be exhibited by a campaign which is familiar or resonates well, but which is seasonal or for a trendy item.
Slow time to maximum, fast time until decay tapers. For example, this behavior would be exhibited by a campaign is complex or takes many exposures to sink in to audience thinking, but then makes a lasting impact.
Slow time to maximum, slow time until decay tapers. For example, this behavior would be exhibited by a campaign is complex or takes many exposures to sink in to audience thinking, and then quickly becomes irrelevant.

### Using Result-Based Metrics to Take Actions

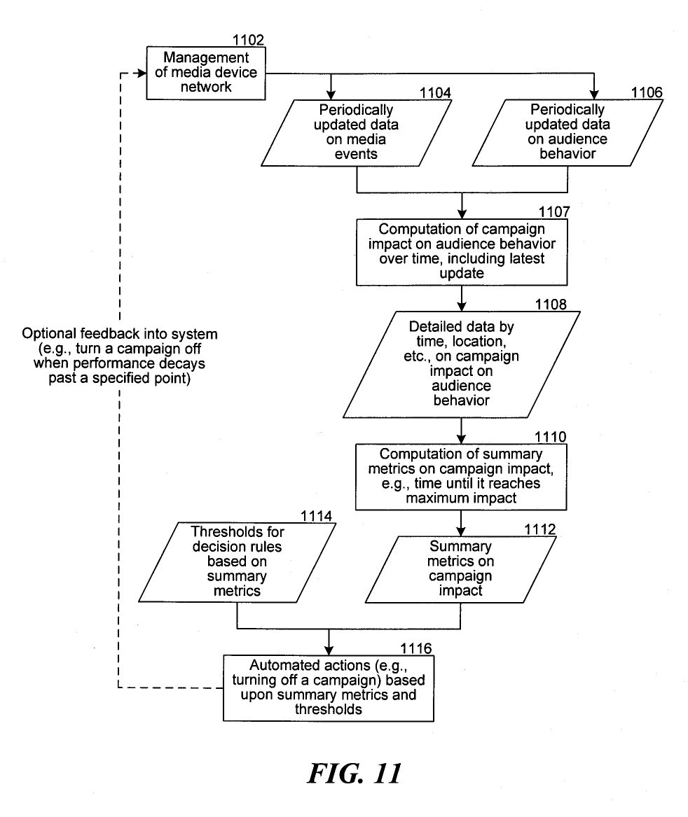

FIG. 11 is a flow diagram illustrating a method in some embodiments for assessing the change in impact of a campaign over time, which can optionally feed back into the management of the media devices where the campaign is displayed. The embodiment illustrated therein enhances upon the above embodiment by triggering actions upon certain thresholds or criteria based upon the above metrics. The actions can include a notification to a user, a change to the scheduling of the advertising campaign on the in-store media devices (for example, increasing the media effort, or removing the advertising campaign from the schedule), a change to the price of the advertising, etc. As a specific example, the advertiser may decide that the advertising campaign should be automatically canceled if a version of RPM either goes below a certain level, or has increasing decay (negative second derivative) for one straight week. Another example would be a user asking to be notified when the total value of incremental sales delivered by the advertising campaign equals or exceeds the total amount paid for the advertising campaign.

In the illustrated embodiment, management of a media device network 1102 includes, at block 1107, computing campaign impact on audience behavior over time based on periodically updated data on media events 1104 and periodically updated data on audience behavior 1106. The computation at block 1107 provides detailed data 1108 that can be sorted based on time, location, etc. to assess campaign impact on audience behavior. At block 1110, the method computes a summary of metrics on campaign impact (e.g., time until the campaign reaches maximum impact) and produces summary metrics 1112 on campaign impact. At block 1116, the method employs summary metrics 1112 and thresholds 1114 for decision rules based on summary metrics to automate actions (e.g., to turn off a campaign when campaign performance decays past a specified point, increase display frequency, etc.) based on the summary metrics and thresholds.

Another example of using the assessed impact of a campaign over time to improve the efficiency of the campaign arises in a situation where multiple campaigns are being evaluated simultaneously. If multiple campaigns are being evaluated, the least efficient campaign may be removed from the evaluation process if the performance of the campaign does not exceed a minimum performance standard. In some embodiments, a user can divide audience behavior as normalized by audience exposure into different demographic groups, and attempt to find the combination of campaign and demographic group that provides the best metrics. Campaigns having the best metrics may be emphasized for that demographic group in future scheduling.

### CONCLUSION

Digital signs and other media devices are being used more and more in settings such as retail stores, shopping malls, sports facilities, and so on. These devices provide advertisers new and impactful ways to reach their audience, but the current art gives little support for the planning, operation and optimization of marketing campaigns on these devices.

This document has described methods to pull together data on how the devices were used, combine it with data on how the audience responded, and determine connections between the two types of data. This can in turn be used to compute various measures of campaign effectiveness. Other data such as demographic profiles, weather, inventory levels, and so on can also be included in the analysis of campaign effectiveness. Using these techniques, advertisers and other entities can measure the impact of their campaigns, optimize the purchasing and scheduling of marketing campaigns and create automated rules which trigger actions or notifications, and assess the efficiency of a campaign over time.

This document refers to public spaces, public places, and public locations interchangeably. All such locations can be publicly or privately owned, but are locations that natural persons can generally access. Examples of such locations are stores, malls, distribution centers, warehouses, libraries, restaurants, cafeterias, offices, streets, sidewalks, storefronts, building lobbies, elevators, and so forth.

Words in the above Description using the singular or plural number may also include the plural or singular number, respectively. For example, in measuring, analyzing, and optimizing a campaign, the methods could also apply to a set of campaigns. Additionally, the words “herein,” “above,” “below” and words of similar import, when used in this application, shall refer to this application as a whole and not to any particular portions of this application. When the word “or” is used in reference to a list of two or more items, that word covers all of the following interpretations of the word: any of the items in the list, all of the items in the list, and any combination of the items in the list. Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, although temporal association is described in terms of finding the set of media events which could have impacted a particular audience behavior event, various other implementations to achieve the same results are possible (such as, examining each media event and searching for audience behavior events which it could have influenced).

The teachings of the invention provided herein can be applied to other systems, not necessarily the system described herein. These and other changes can be made to the invention in light of the detailed description. The elements and acts of the various embodiments described above can be combined to provide further embodiments.

Aspects of the invention can be modified, if necessary, to employ the systems, functions, and concepts of the various references described above to provide yet further embodiments of the invention.

These and other changes can be made to the invention in light of the above detailed description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated.

We claim:

1. A computer-implemented method for measuring an effectiveness of a marketing campaign that is displayed to natural persons on a plurality of display devices at public locations, comprising:
receiving audience behavior data which reflects a plurality of audience behavior events, each of the audience behavior events reflecting an observable action performed by a natural person at a public location;
receiving media event data which reflects the display of a marketing campaign on a plurality of display devices that are located at public locations, the media event data identifying at least a time and a place associated with the display of the marketing campaign, the marketing campaign containing media content that is observable by a natural person viewing a display device on which the campaign is displayed;
identifying a correspondence between the audience behavior data and media event data and determining an impact of the marketing campaign on natural persons based on the correspondence;
receiving audience exposure data which reflects a plurality of audience exposure events, each of the audience exposure events associated with an exposure of a natural person at a public location to the marketing campaign; and
determining an effectiveness of the marketing campaign as a measure of audience exposure by evaluating the determined impact of the marketing campaign relative to the audience exposure data.

2. The computer-implemented method of claim 1, wherein identifying a correspondence between the audience behavior data and media event data includes temporally associating the audience behavior data and media event data.

3. The computer-implemented method of claim 2, wherein temporally associating the audience behavior data and media event data comprises:
receiving a selected time period that is a time interval of specified duration;
selecting an audience behavior event from the audience behavior data, the audience behavior event associated with an identified time at which the audience behavior event occurred; and
selecting media content that was displayed within the time interval of specified duration as measured from the identified time at which the audience behavior event occurred.

4. The computer-implemented method of claim 1, further comprising automating a decision pertaining to future scheduling of media content based on the determined effectiveness of the marketing campaign.

5. The computer-implemented method of claim 1, wherein the audience exposure data is received from two or more sources of audience exposure data.

6. The computer-implemented method of claim 1, wherein the audience exposure data is derived from data generated by a monitoring device.

7. The computer-implemented method of claim 6, wherein the monitoring device is selected from the group consisting of cameras, motion detectors, and heat sensors.

8. The computer-implemented method of claim 6, wherein the monitoring device is capable of tracking a location of a natural person.

9. The computer-implemented method of claim 6, wherein the monitoring device is capable of tracking a location of an item.

10. The computer-implemented method of claim 6, wherein the monitoring device is a radio frequency identification (RFID) tag.

11. The computer-implemented method of claim 1, wherein the audience exposure data is derived from data received from a natural person.

12. The computer-implemented method of claim 8, wherein the natural person is a participant on a panel or a focus group.

13. The computer-implemented method of claim 1, wherein the audience exposure data is derived from data reflecting a use of a kiosk.

14. The computer-implemented method of claim 1, wherein evaluating the determined impact of the marketing campaign relative to the audience exposure data comprises taking a ratio of audience exposure data and determined impact of the marketing campaign.

15. The computer-implemented method of claim 1, wherein evaluating the determined impact of the marketing campaign relative to the audience exposure data comprises normalizing audience exposure data and determined impact of the marketing campaign.

16. The computer-implemented method of claim 1, wherein the audience exposure data contains data reflecting a demographic group of each natural person.

17. A computer-readable storage medium storing computer-executable instructions that, when executed, cause a computing system to perform a method for measuring an effectiveness of a marketing campaign that is displayed to natural persons on a plurality of display devices at public locations, the method comprising:
receiving audience behavior data which reflects a plurality of audience behavior events, each of the audience behavior events reflecting an observable action performed by a natural person at a public location;
receiving media event data which reflects the display of a marketing campaign on a plurality of display devices that are located at public locations, the media event data identifying at least a time and a place associated with the display of the marketing campaign, the marketing campaign containing media content that is observable by a natural person viewing a display device on which the campaign is displayed;
identifying a correspondence between the audience behavior data and media event data and determining an impact of the marketing campaign on natural persons based on the correspondence;
receiving audience exposure data which reflects a plurality of audience exposure events, each of the audience exposure events associated with an exposure of a natural person at a public location to the marketing campaign; and
determining an effectiveness of the marketing campaign as a measure of audience exposure by evaluating the determined impact of the marketing campaign relative to the audience exposure data.

18. The computer-readable storage medium of claim 17, wherein identifying a correspondence between the audience behavior data and media event data includes temporally associating the audience behavior data and media event data.

19. The computer-readable storage medium of claim 18, wherein temporally associating the audience behavior data and media event data comprises:
receiving a selected time period that is a time interval of specified duration;
selecting an audience behavior event from the audience behavior data, the audience behavior event associated with an identified time at which the audience behavior event occurred; and
selecting media content that was displayed within the time interval of specified duration as measured from the identified time at which the audience behavior event occurred.

20. The computer-readable storage medium of claim 17, further comprising automating a decision pertaining to future scheduling of media content based on the determined effectiveness of the marketing campaign.

21. The computer-readable storage medium of claim 17, wherein the audience exposure data is received from two or more sources of audience exposure data.

22. The computer-readable storage medium of claim 17, wherein the audience exposure data is derived from data generated by a monitoring device.

23. The computer-readable storage medium of claim 22, wherein the monitoring device is selected from the group consisting of cameras, motion detectors, and heat sensors.

24. The computer-readable storage medium of claim 22, wherein the monitoring device is capable of tracking a location of a natural person.

25. The computer-readable storage medium of claim 22, wherein the monitoring device is capable of tracking a location of an item.

26. The computer-readable storage medium of claim 22, wherein the monitoring device is a radio frequency identification (RFID) tag.

27. The computer-readable storage medium of claim 17, wherein the audience exposure data is derived from data received from a natural person.

28. The computer-readable storage medium of claim 24, wherein the natural person is a participant on a panel or a focus group.

29. The computer-readable storage medium of claim 17, wherein the audience exposure data is derived from data reflecting a use of a kiosk.

30. The computer-readable storage medium of claim 17, wherein evaluating the determined impact of the marketing campaign relative to the audience exposure data comprises taking a ratio of audience exposure data and determined impact of the marketing campaign.

31. The computer-readable storage medium of claim 17, wherein evaluating the determined impact of the marketing campaign relative to the audience exposure data comprises normalizing audience exposure data and determined impact of the marketing campaign.

32. The computer-readable storage medium of claim 17, wherein the audience exposure data contains data reflecting a demographic group of each natural person.

33. A system for measuring performance of an marketing campaign that is displayed to natural persons on a plurality of display devices at public locations, comprising:
a plurality of display devices located at public locations that display an marketing campaign to an audience and record media event data characterizing the display of the marketing campaign;
a plurality of monitoring devices located at public places that record audience exposure events to the displayed marketing campaign as audience exposure data;
a communication component to receive media event data, audience exposure data, and audience behavior data characterizing a plurality of audience behavior events reflecting observable actions performed by the audience following display of the marketing campaign; and
an analysis component that is configured to:
associate the media event data with the audience behavior data and determine an impact of the marketing campaign on the audience; and
determine an effectiveness of the marketing campaign as a measure of audience exposure by evaluating the determined impact of the marketing campaign relative to the audience exposure data.

34. The system of claim 33, wherein the analysis component associates the audience behavior data and the media event data by a temporal association.

35. The system of claim 33, wherein the analysis component is further configured to automate a decision pertaining to future marketing campaigns based on the determined effectiveness of the marketing campaign.

36. The system of claim 33, wherein a monitoring device is capable of tracking a location of a natural person in the audience.

37. The system of claim 36, wherein a monitoring device is selected from the group consisting of cameras, motion detectors, and heat sensors.

38. The system of claim 36, wherein a monitoring device is further capable of capturing data reflecting a demographic group of the natural person in the audience.

39. The system of claim 33, wherein a monitoring device is capable of tracking a location of an item.

40. The system of claim 39, wherein the monitoring device is a radio frequency identification (RFID) tag.

41. The system of claim 41, wherein the analysis component evaluates the determined impact of the marketing campaign relative to the audience exposure data by taking a ratio of audience exposure data and determined impact of the marketing campaign.

42. The system of claim 33, wherein the analysis component evaluates the determined impact of the marketing campaign relative to the audience exposure data by normalizing audience exposure data and determined impact of the marketing campaign.

43. A computer-implemented method for measuring an effectiveness of a marketing campaign that is displayed to natural persons on a plurality of display devices at public locations, comprising:
receiving audience behavior data which reflects a plurality of audience behavior events, each of the audience behavior events reflecting an observable action performed by a natural person at a public location;
receiving media event data which reflects the display of a marketing campaign on a plurality of display devices that are located at public locations, the media event data identifying at least a time and a place associated with the display of the marketing campaign, the marketing campaign containing media content that is observable by a natural person viewing a display device on which the campaign is displayed;
receiving audience exposure data which reflects a plurality of audience exposure events, each of the audience exposure events associated with an exposure of a natural person at a public location to the marketing campaign; and
determining an effectiveness of the marketing campaign as a measure of audience exposure by evaluating the audience behavior data and media event data relative to the audience exposure data.

44. The computer-implemented method of claim 43, wherein the audience behavior data and media event data are evaluated by determining a temporal association between the audience behavior data and media event data.

45. The computer-implemented method of claim 44, wherein determining the temporal association between the audience behavior data and media event data comprises:
receiving a selected time period that is a time interval of specified duration;
selecting an audience behavior event from the audience behavior data, the audience behavior event associated with an identified time at which the audience behavior event occurred; and
selecting media content that was displayed within the time interval of specified duration as measured from the identified time at which the audience behavior event occurred.

46. The computer-implemented method of claim 43, further comprising automating a decision pertaining to future scheduling of media content based on the determined effectiveness of the marketing campaign.

47. The computer-implemented method of claim 43, wherein the audience exposure data is received from two or more sources of audience exposure data.

48. The computer-implemented method of claim 43, wherein the audience exposure data is derived from data generated by a monitoring device.

49. The computer-implemented method of claim 48, wherein the monitoring device is selected from the group consisting of cameras, motion detectors, and heat sensors.

50. The computer-implemented method of claim 48, wherein the monitoring device is capable of tracking a location of a natural person.

51. The computer-implemented method of claim 48, wherein the monitoring device is capable of tracking a location of an item.

52. The computer-implemented method of claim 48, wherein the monitoring device is a radio frequency identification (RFID) tag.

53. The computer-implemented method of claim 43, wherein the audience exposure data is derived from data received from a natural person.

54. The computer-implemented method of claim 50, wherein the natural person is a participant on a panel or a focus group.

55. The computer-implemented method of claim 43, wherein the audience exposure data is derived from data reflecting a use of a kiosk.

56. The computer-implemented method of claim 43, wherein evaluating the audience behavior data and media event data relative to the audience exposure data comprises:
identifying a correspondence between the audience behavior data and media event data and determining an impact of the marketing campaign on natural persons based on the correspondence; and
taking a ratio of audience exposure data and determined impact of the marketing campaign.

57. The computer-implemented method of claim 43, wherein evaluating the audience behavior data and media event data relative to the audience exposure data comprises:
identifying a correspondence between the audience behavior data and media event data and determining an impact of the marketing campaign on natural persons based on the correspondence; and
normalizing the audience exposure data and determined impact of the marketing campaign.

58. The computer-implemented method of claim 43, wherein the audience exposure data contains data reflecting a demographic group of each natural person.
